(19) United States
(12) Patent Application Publication
(10) Pub. No.: US 2026/0274517 A1
(43) Pub. Date: Sep. 17, 2026

(54) HANDLE FOR WHEELED CONTAINER

(71) Applicant: Nickolas Brands, LLC, Sarasota, FL (US)

(72) Inventors: Nickolas Reinhart, Sarasota, FL (US); Joe Klein, Findlay, OH (US); Ben Sayalith, Findlay, OH (US)

(21) Appl. No.: 19/566,274

(22) Filed: Mar. 13, 2026

Related U.S. Application Data
(60) Provisional application No. 63/771,746, filed on Mar. 14, 2025.

(51) Int. Cl. B65D 25/28; B62B 3/00; B62B 5/06; B65D 1/26

(52) U.S. Cl. CPC B65D 25/2841; B62B 3/005; B62B 5/067; B65D 1/26

(57) ABSTRACT

The present invention relates to a container that may include a base wall having a peripheral edge, a first side wall, and a second side wall disposed opposite the first side wall. Each of the first side wall and the second side wall may extend upwardly from the peripheral edge of the base wall. The container may include a first end wall and a second end wall disposed opposite the first end wall. Each of the first end wall and the second end wall may extend upwardly from the peripheral edge of the base wall. A first mounting component and a second mounting component may be disposed on the second end wall. Each of the first mounting component and the second mounting component may include an L-shaped component and an aperture formed in the L-shaped component. The container may include a handle having a first pin configured to couple to the first mounting component and a second pin configured to couple to the second mounting component. The handle may be configured to rotate between a secured handle position and an extended position.

### CROSS-REFERENCE TO RELATED APPLICATIONS

This application claims the benefit of U.S. Provisional Application No. 63/771,746, filed on Mar. 14, 2025. The entire disclosure of the above application is incorporated herein by reference.

### FIELD

The present technology relates to storage containers and organizational systems, and, more particularly, to portable storage containers with enhanced mobility features.

### INTRODUCTION

This section provides background information related to the present disclosure which is not necessarily prior art.

Organizational systems are commonly used in homes, garages, basements, and other areas where items accumulate. A wide range of storage solutions exists to manage accumulated items based on user needs. However, many storage containers, while functional for basic storage needs, are limited with respect to, durability, mobility, and ease of use. For example, the weight of stored items, combined with the weight of the storage container, may make repositioning and moving the storage container challenging without assistance. This limitation in particular may impact users who may need to frequently access, move, or reorganize storage spaces.

Large storage containers in particular are limited with respect to structural integrity and/or practical functionality. In order to optimize structural integrity and practical functionality, storage containers are typically either too small to provide adequate storage capacity or, if larger, too heavy to be practically useful for regular organization and reorganization needs. Many storage containers fail to provide an optimal balance between storage capacity and portability. Additionally, many storage containers lack enhanced mobility features, making the storage containers impractical for users who may need to lift and transport stored items between different locations. As an example, storage containers may include handles that interfere with efficient storage and stacking capabilities, forcing users to choose between accessibility and space optimization.

Mobility features for storage containers, such as wheels and handles, also may result in compromised structural integrity and/or reduced storage capacity. The addition of wheels and handles may lead to decreased stability, particularly when containers are stacked, creating safety concerns and limiting the practical utility of the storage containers. Additionally, storage containers may require complex handle assemblies involving separate hinge pins, push nuts, fasteners, and other components that must be individually assembled and may negatively impact the structural integrity of the handle and/or the storage container as a whole. These additional parts may increase both material costs and assembly time during manufacturing. The multiple component assemblies may also make field repairs impractical or impossible if individual parts are lost or damaged.

Accordingly, there is a continuing need for storage containers that effectively balance mobility, structural integrity, and storage capacity. Desirably, such storage containers would provide enhanced portability features while maintaining stable stacking capabilities and maximizing available storage space.

### SUMMARY

In concordance with the instant disclosure, a storage container that effectively balances mobility, structural integrity, and storage capacity, and provides enhanced portability features while maintaining stable stacking capabilities and maximizing available storage space, has surprisingly been discovered.

The present technology includes articles of manufacture, systems, and processes that relate to portable storage containers with enhanced mobility and stacking features.

In certain embodiments, a container may include a base wall having a peripheral edge, a first side wall, and a second side wall disposed opposite the first side wall. Each of the first side wall and the second side wall may extend upwardly from the peripheral edge of the base wall. The container may include a first end wall and a second end wall disposed opposite the first end wall. Each of the first end wall and the second end wall may extend upwardly from the peripheral edge of the base wall. A first mounting component and a second mounting component may be disposed on the second end wall. Each of the first mounting component and the second mounting component may include an L-shaped component and an aperture formed in the L-shaped component. The container may include a handle having a first pin configured to couple to the first mounting component and a second pin configured to couple to the second mounting component. The handle may be configured to rotate between a secured handle position and an extended position.

In certain embodiments, a container may include a base wall having a peripheral edge, a first side wall, and a second side wall disposed opposite the first side wall. Each of the first side wall and the second side wall may extend upwardly from the peripheral edge of the base wall. The container may include a first end wall and a second end wall disposed opposite the first end wall. Each of the first end wall and the second end wall may extend upwardly from the peripheral edge of the base wall. A lip may extend outwardly from a perimeter of an opening formed by an upper edge of the first side wall, the second side wall, the first end wall, and the second end wall. A flange may extend outwardly from the lip and may circumscribe the lip. The flange may include a first flange section and a second flange section. The first flange section may have a first flange height that is greater than a second flange height of the second flange section. A first wheel well may be formed in the base wall, the first side wall, and the first end wall, and a second wheel well may be formed in the base wall, the second side wall, and the first end wall. A first wheel may be disposed in the first wheel well and a second wheel may be disposed in the second wheel well. A first mounting component and a second mounting component may be disposed on the second end wall. Each of the first mounting component and the second mounting component may include an L-shaped component and an aperture formed in the L-shaped component. A hand grip may be disposed centrally adjacent the second end wall. The hand grip may include a first end and a second end disposed opposite the first end. The container may include a handle including a first pin configured to couple to the first mounting component and a second pin configured to couple to the second mounting component. The handle may be configured to rotate between a secured handle position and an extended position. The first mounting component may be positioned adjacent the first end of the hand grip and the second mounting component may be positioned adjacent the second end of the hand grip.

In certain embodiments, a method of using a container may include a first step of providing a container. The container may include a base wall having a peripheral edge, a first side wall, and a second side wall disposed opposite the first side wall. Each of the first side wall and the second side wall may extend upwardly from the peripheral edge of the base wall. The container may include a first end wall and a second end wall disposed opposite the first end wall. Each of the first end wall and the second end wall may extend upwardly from the peripheral edge of the base wall. A first mounting component and a second mounting component may be disposed on the second end wall. Each of the first mounting component and the second mounting component may include an L-shaped component and an aperture formed in the L-shaped component. The container may include a handle having a first pin configured to couple to the first mounting component and a second pin configured to couple to the second mounting component. The handle may be configured to rotate between a secured handle position and an extended position. A second step of securing the handle in the secured handle position during storage and a third step of securing the handle in the extended position during transport may be included in the method.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a top perspective view of a wheeled container according to an embodiment of the present disclosure;

FIG. 2 is a bottom perspective view thereof;

FIG. 3 is a top perspective view of a handle of the wheeled container of FIG. 1;

FIG. 4 is a rear perspective view thereof;

FIG. 5 is an enlarged perspective view of an end of the handle of FIG. 3;

FIG. 6 is an enlarged perspective view of a mounting component of the wheeled container of FIG. 1;

FIG. 7 is a front elevational view of the wheeled container of FIG. 1;

FIG. 8 is a top perspective view of a plurality of wheeled containers of FIG. 1 shown with the handles in a stowed position, according to an embodiment of the present disclosure; and

FIG. 9 is a schematic block diagram illustrating a method of using a wheeled container, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves storage capacity and enhances structural integrity of storage containers. Specifically, the present technology improves portability features such as the handle and wheels of storage containers while maintaining stable stacking capabilities and maximizing available storage space.

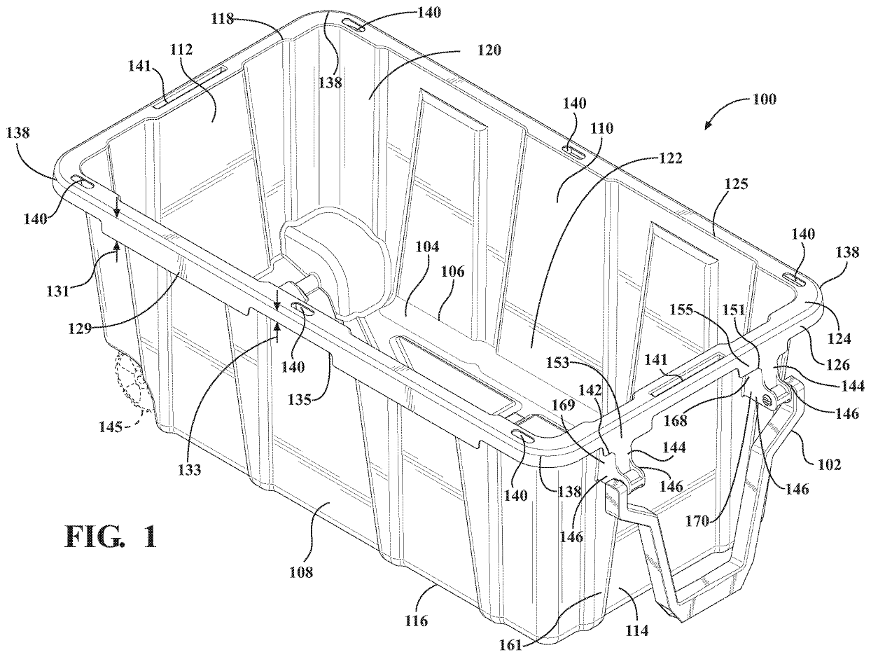

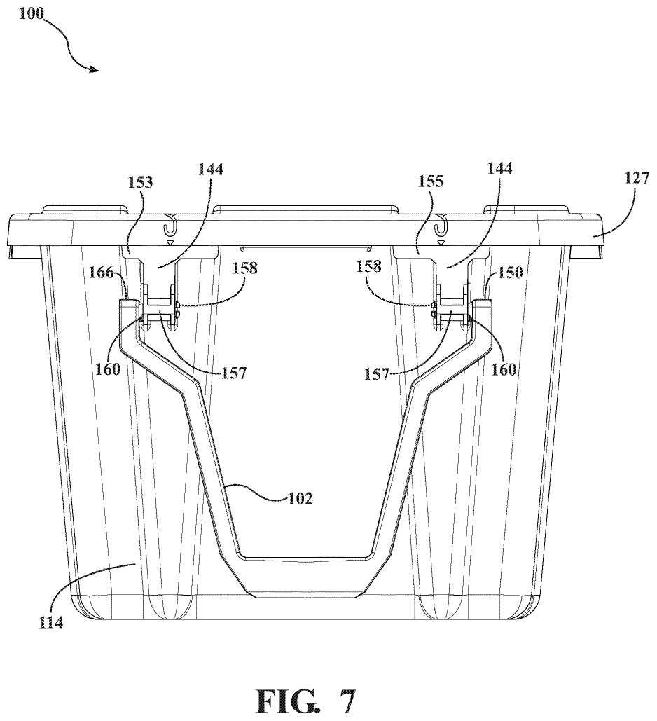

With reference to FIGS. 1-8, a wheeled container 100 with a handle 102 is shown. The wheeled container 100 may be a plastic storage tote. However, it should be appreciated that various storage containers made of different materials are contemplated and may therefore be included within the scope of this disclosure. The wheeled container 100 may be fabricated from plastic through injection molding or blow molding processes, as examples. Other processes and types of materials may be employed, as determined by a skilled artisan.

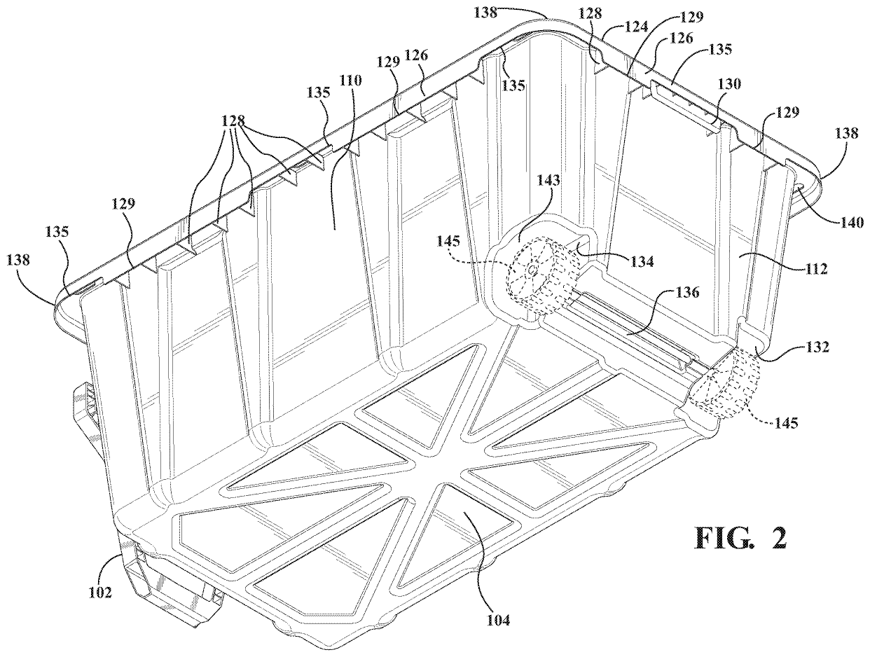

As shown in FIGS. 1 and 2, the wheeled container 100 may include a base wall 104 having a peripheral edge 106. A first side wall 108 and a second side wall 110 disposed opposite the first side wall 108 may extend upwardly from the peripheral edge 106 of the base wall 104. A first end wall 112 and a second end wall 114 disposed opposite the first end wall 112 may extend upwardly from the peripheral edge 106 of the base wall 104. Each of the first and second side walls 108, 110 may be positioned between the first and second end walls 112, 114, and each of the first and second side walls 108, 110 and the first and second end walls 112, 114, may include a lower edge 116 that may be integrally formed with, disposed on, and/or coupled to the peripheral edge 106 of the base wall 104. Each of the first and second side walls 108, 110 and each of the first and second end walls 112, 114 may be spaced apart from one another and may extend substantially perpendicular to the base wall 104.

Each of the first and second side walls 108, 110 and each of the first and second end walls 112, 114 may include an upper edge 118 that may be spaced apart from and disposed opposite the lower edge 116. The upper edge 118 of the first and second side walls 108, 110 and the first and second end walls 112, 114 may collectively define an opening 120 that may provide access to a hollow interior cavity 122 of the wheeled container 100. The hollow interior cavity 122 may be defined by the base wall 104, the first and second side walls 108, 110, and the first and second end walls 112, 114.

The upper edge 118 of the first and second side walls 108, 110 and the first and second end walls 112, 114 may include a lip 124 that may extend around a perimeter 125 of the opening 120. The lip 124 may be configured to selectively receive and engage with a lid 127 to selectively cover the opening 120 and enclose the hollow interior cavity 122. The lip 124 may be circumscribed by a flange 126 that may extend outwardly from the lip 124. The flange 126 may extend at substantially ninety degrees relative to the lip 124 in a downward direction toward the base wall 104, according to certain embodiments. A plurality of support ribs 128 may be disposed around the perimeter 125 of the opening 120. Each of the support ribs 128 may extend between and couple to and/or be integrally formed with one or more of the flange 126, the lip 124, and the adjacent first side wall 108, second side wall 110, first end wall 112, or second wall 114. The support ribs 128 may be configured to provide structural reinforcement to the lip 124, the flange 126, and to the adjacent first side wall 108, second side wall 110, first end wall 112, or second wall 114.

A hand grip 130 may be disposed generally centrally adjacent each of the first and second end walls 112, 114 and the flange 126. The hand grip 130 may extend downwardly from the lip 124. Additional support ribs 128 may be disposed between each hand grip 130 and the respective first or second end wall 112, 114, as well as between each hand grip 130 and the respective adjacent flange 126. The support ribs 128 may be configured to provide structural reinforcement to the hand grip 130, the first and second end wall 112, 114, and the flange 126.

The flange 126 may vary in height extending downwardly from the lip 124. A first flange section 129 may have a first flange height 131 that is greater than a second flange height 133 of a second flange section 135. Each corner 138 formed between one of the first and second side walls 108, 110 and one of the first and second end walls 112, 114 may have a first flange section 129 disposed on either side of the corner 138 configured to provide enhanced structural reinforcement. A second flange section 135 may be disposed between each first flange section 129 to minimize material usage while maintaining sufficient support for engagement with the lid 127. The support ribs 128 may work in combination with the variable height of the flange 126 to provide targeted structural reinforcement as needed. It should be appreciated that a height of each support rib 128 may directly correspond with one of the first flange height 131 or the second flange height 133. In certain embodiments, a height of each support rib 128 may be substantially the same as one of an adjacent first flange height 131 or an adjacent second flange height 133.

The lip 124 may include one or more lip openings 140 that may be formed therein and spaced apart around the perimeter 125 of the opening 120. The lip openings 140 may be configured to provide ventilation and reduce material usage while maintaining the structural integrity of the lip 124. In certain embodiments, the lip openings 140 may be uniformly spaced along each of the first and second side walls 108, 110. The lip 124 may include elongated openings 141 that may be formed in the lip 124 adjacent each of the first and second end walls 112, 114. The elongated openings 141 may be positioned adjacent the hand grips 130 and disposed centrally on each of the first and second end walls 112, 114. In certain embodiments, the elongated openings 141 may extend into, through, or partially through the hand grips 130. The alignment of the elongated openings 141 and the hand grips 130 may provide additional ventilation while maintaining the structural integrity of the lip 124 where a user may grip the wheeled container 100. The elongated openings 141 may be symmetrically positioned relative to one another and may correspond with the hand grips 130 disposed on each of the first and second end walls 112, 114.

A first wheel well 132 may be formed in the base wall 104, the first side wall 108, and the first end wall 112. A second wheel well 134 may be formed in the base wall 104, the second side wall 110, and the first end wall 112. Each of the first and second wheel wells 132, 134 may be configured to receive a wheel 145. Each of the first and second wheel wells 132, 134 may extend upwardly from the base wall 104 and into the first side wall 108 and the first end wall 112, and the second side wall 110 and the first end wall 112, respectively, to form recessed sections 143 that may be configured to partially or completely house each wheel 145. The first and second wheel wells 132, 134 may be disposed adjacent to an intersection of the base wall 104, the first side wall 108, and the first end wall 112, and the base wall 104, the second side wall 110, and the first end wall 112, respectively.

Each wheel 145 may be rotatably mounted within the respective first and second wheel wells 132, 134. An axle 136 may extend between and couple the wheels 145, thereby allowing each wheel 145 to rotate on a common axle to minimize the complexity of assembly and facilitate alignment of the wheels 145 for smooth rolling and straight tracking when pulling the wheeled container 100 using the wheels 145. The axle 136 may be rotatably supported within each of the first and second wheel wells 132, 134 to facilitate smooth movement of the wheeled container 100.

Although the drawings depict first and second wheel wells 132, 134 and corresponding wheels 145, it should be appreciated that a skilled artisan may select and incorporate any suitable number and configuration of wheel wells 132, 134 and wheels 145, as desired, based on the size and intended use of the wheeled container 100. The number, size, and placement of the wheel wells 132, 134 and wheels 145 may be scaled accordingly to provide adequate support and mobility for wheeled containers 100 of varying sizes and dimensions. It should be appreciated that in certain embodiments, the wheeled container 100 may not include wheels 145.

The second end wall 114 may include a first mounting component 142 and a second mounting component 151 disposed adjacent to the lip 124 and the second end wall 114. The first and second mounting components 142, 151 may be spaced apart from one another and positioned on opposite sides of the hand grip 130. In certain embodiments, the first mounting component 142 may be co-formed with a first flange 153 and the second mounting component 151 may be co-formed with a second flange 155. Each of the first and second mounting components 142, 151 may include a back section 144 integrally formed with the first flange 153 and the second flange 155, respectively, and may include a generally L-shaped component 146 disposed on either side of the back section 144. A connecting wall 157 may extend between each L-shaped component 146 of the first mounting component 142 and each L-shaped component 146 of the second mounting component 151. Each generally L-shaped component 146 may be configured to extend outwardly from the back section 144 at a generally 90 degree angle. As shown in FIG. ***, each L-shaped component 146 may include an aperture, such as a cylindrical aperture 148, that may be configured to receive and rotatably support the handle 102. Each cylindrical aperture 148 may be generally in alignment with one another to permit the handle 102 to extend between and be supported by each of the first and second mounting components 142, 151.

Each of the first and second mounting components 142, 151 may be configured to rotatably couple the handle 102 to the second end wall 114. The cylindrical apertures 148 disposed in the L-shaped components 146 of the first mounting component 142 may be sized and configured to receive and rotatably support the a first end 150 of the handle 102. The cylindrical apertures 148 disposed in the L-shaped components 146 of the second mounting component 151 may be sized and configured to receive and rotatably support a second end 166 of the handle 102. The cylindrical apertures 148 may permit the handle 102 to rotate freely between a secured handle position wherein the handle 102 is directly adjacent to the second end wall 114 and an extended position where the handle 102 is pulled a desired length away from the second end wall 114. The L-shaped configuration of each L-shaped component 146 may provide a desired clearance from the second end wall 114 for the handle 102 to rotate through a desired range of rotation while maintaining secure attachment to the wheeled container 100.

The handle 102 may be disposed on the second end wall 114 and positioned opposite to the first end wall 112 including the first and second wheel wells 132, 134 and wheels 145, thereby allowing the user to grip the handle 102, lift a front portion 161 of the wheeled container 100, and tilt the wheeled container 100 onto the wheels 145. Advantageously, the wheeled container 100 may be pulled or pushed on the wheels 145 using the handle 102 to facilitate movement of the wheeled container 100 to different locations. The first and second mounting components 142, 151 may be positioned at any desired location on the second end wall 114 that may provide optimal leverage for tilting and rolling the wheeled container 100 on the wheels 145.

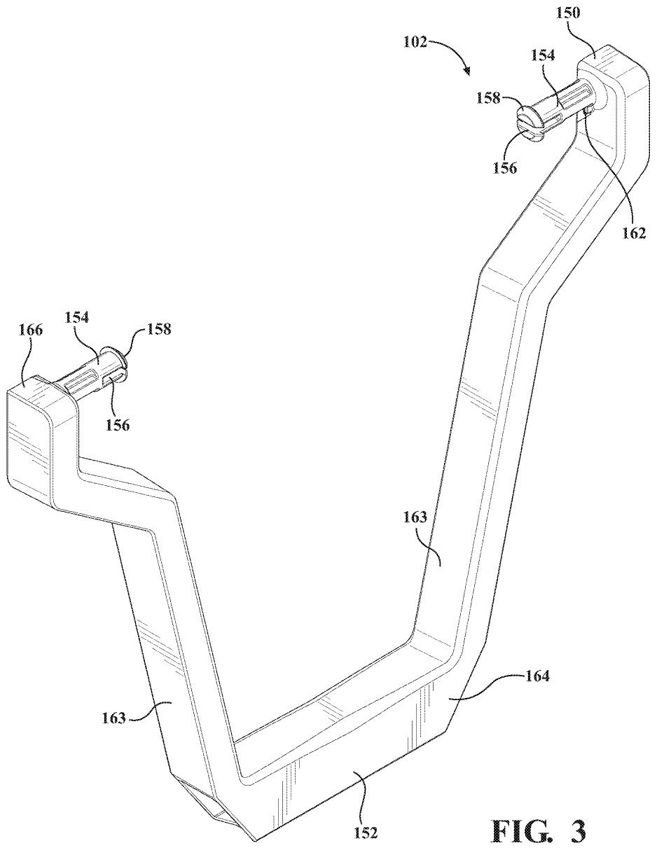

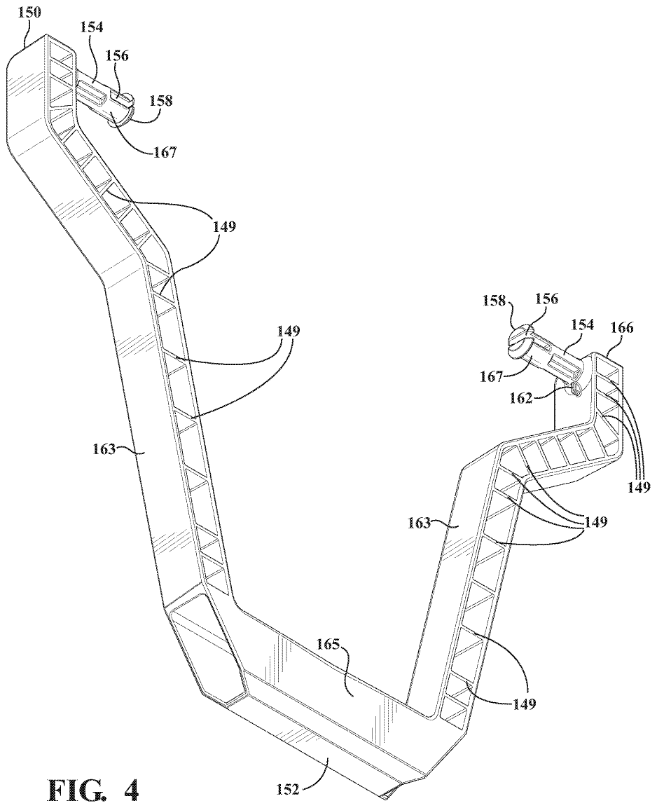

With reference to FIGS. 3 and 4, the handle 102 may be formed as a unitary structure having a side wall 163, a front wall 164, and a rear wall 165. A plurality of handle support ribs 149 may be formed adjacent and/or between one or more of the side wall 163, the front wall 164, and the rear wall 165 to provide structural reinforcement to the handle 102. The handle support ribs 149 may extend between and be integrally formed with or coupled to one or more of the side wall 163, the front wall 164, and the rear wall 165 of the handle 102 to enhance the rigidity and durability of the handle 102. The handle 102 may have a substantially V-shaped body having the first end 150, the second end 166, and a central handle portion 152 disposed between the first end 150 and the second end 166. It should be understood that the handle 102 may have any other suitable shape and configuration, as desired, or as suited for a particular application or manufacturing process. As an example, the handle 102 may have a U-shaped body and may have a cross-sectional shape that is generally U-shaped, V-shaped, round, or any other suitable shape, as determined by one skilled in the art.

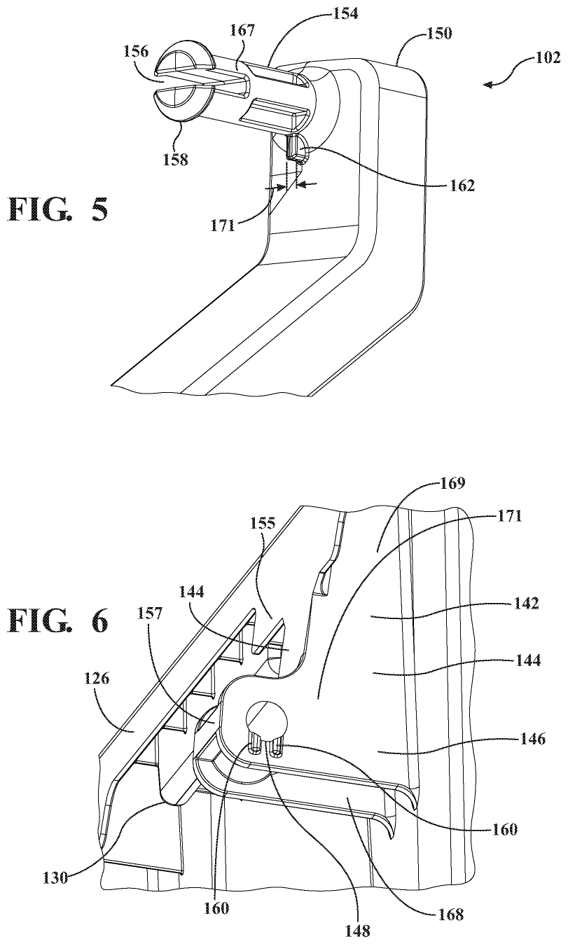

Each of the first end 150 and the second end 166 of the handle 102 may include a pin 154 that may extend outwardly therefrom, as shown in FIG. 5. Each pin 154 may have dimensions that generally correspond to the dimensions of the cylindrical apertures 148 in each of the first and second mounting components 142, 151. Each pin 154 may include a slot 156 or recessed area that may be formed in a distal end 167 of the pin 154 and may extend through any suitable length of the pin 154. The slot 156 may be configured to allow the pin 154 to be resiliently compressed or pinched together to facilitate insertion of the pin 154 into each corresponding cylindrical aperture 148. Each pin 154 may further include a ledge 158 that may be disposed at the distal end 167 of the pin 154. The ledge 158 may extend radially outward from the distal end 167 of the pin 154 and may be configured to engage with an L-shaped component 146 of each of the first and second mounting components 142, 151 after insertion of the pin 154 through the cylindrical apertures 148. The ledge 158 may be configured to militate against undesirable movement of the pin 154 during use of the handle 102, thereby securing the handle 102 to the wheeled container 100.

With reference to FIGS. 1 and 6, each of the first and second mounting components 142, 151 may include at least one protrusion 160 that may extend downwardly from the cylindrical aperture 148 on an exterior surface 170 of each of the first and second mounting components 142, 151. The handle 102 may include a stay rib 162 that may be formed adjacent to and/or below each pin 154. In certain embodiments, each of the first and second mounting components 142, 151 may include a pair of protrusions 160 spaced apart from one another at a distance that may generally correspond to a width 171 of the stay rib 162. In the secured handle position, the stay rib 162 may be configured to rest between the pair of protrusions 160, with the stay rib 162 having passed over one protrusion 160 during rotation of the handle 102 into the secured handle position. The secured handle position may secure the handle 102 in a secure position during movement, shipping, stacking, or storage of the wheeled container 100. To move the wheeled container 100, the handle 102 may be pulled outwardly, causing the stay rib 162 to pass over the protrusion 160, thereby releasing the handle 102 from the secured handle position. Once released, the handle 102 may be freely rotated to any desired angle. It should be understood that the handle 102, including the pins 154 configured to fit in the cylindrical apertures 148 and the stay rib 162 configured to interact with the protrusions 160, as examples, may provide a resilient assembly that allows for easy assembly and rotation of the handle 102 during use. The resilient assembly may facilitate movement of the stay rib 162 over the protrusions 160 as the user pulls or moves the wheeled container 100 using the handle 102 and may facilitate the secured handle position including the stay rib 162 disposed between the pair of protrusions 160 when the user secures the handle in the secured handle position.

In certain embodiments, each of the first and second mounting components 142, 151 may have first L-shaped component 169 and a second L-shaped component 168. The ledge 158 may be configured to be adjacent the exterior surface 170 of the first L-shaped component 169 of each of the first and second mounting components 142, 151. The protrusion 160 or pair of protrusions 160 may be formed on the exterior surface 170 of the second L-shaped component 168 of each of the first and second mounting components 142, 151.

The central handle portion 152 may include a grip portion (not shown) that may be coupled to or formed integrally with the handle 102. The grip portion may include textured surfaces or ergonomic contours to enhance gripping comfort and control. Additionally, the central handle portion 152 may be configured to receive a rubberized coating or overmolded material that may provide improved grip characteristics and tactile comfort during use of the handle 102. The rubberized coating or overmolded material may be secured to the central handle portion 152 through mechanical bonding, chemical adhesion, or other suitable attachment methods.

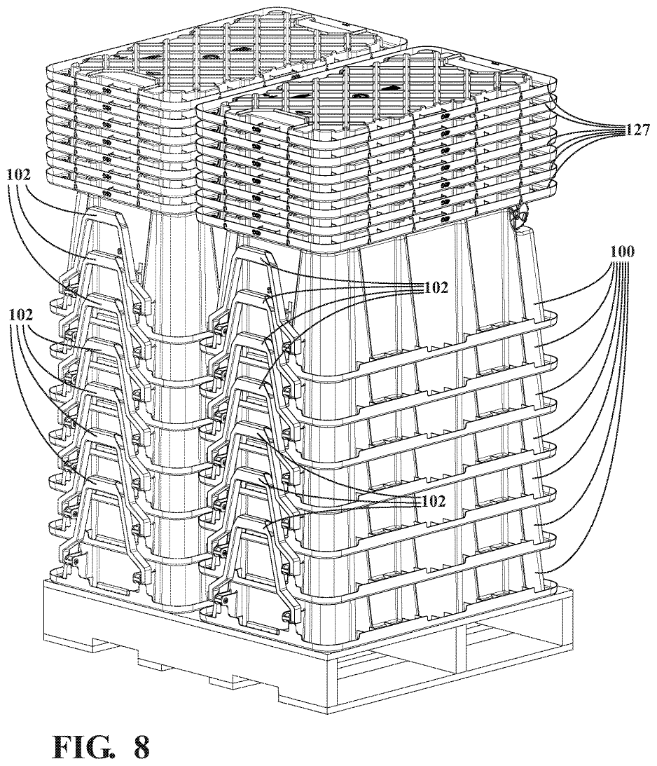

With reference to FIG. 8, a plurality of wheeled containers 100 including handles 102 may be stacked with the handles 102 in the secured handle position. The stay ribs 162 of each handle 102 may rest securely between the protrusions 160 on each of the first and second mounting components 142, 151 thereby maintaining the handles 102 in the secured handle position during transport and stacking of the plurality of wheeled containers 100. The wheeled containers 100 may be configured to nest within one another when stacked, with sufficient clearance between the nested wheeled containers 100 to militate against interference between the respective handles 102. When the handles 102 are in the secured handle position, the nested arrangement may allow the plurality of wheeled containers 100 to be securely stacked while maintaining each handle 102 in the secured handle position. The spacing and clearance between nested wheeled containers 100 may be particularly advantageous during shipping and transport, as it may militate against undesired movement or disengagement of, as well as damage to, the handles 102 in the secured handle position and minimize cost associated with shipping and storing the plurality of wheeled containers 100.

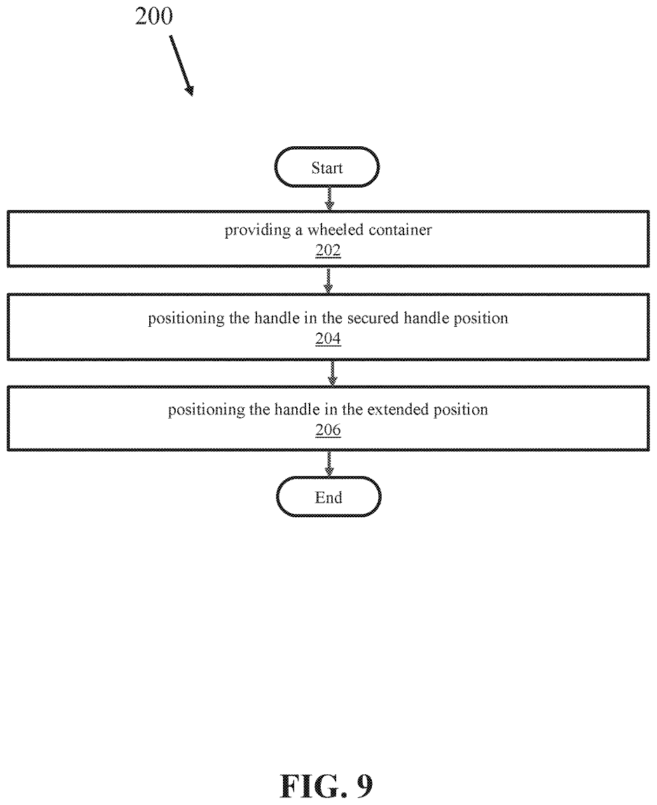

With reference to FIG. 9, a method 200 of using the wheeled container 100 is provided. The method 200 may include a step 202 of providing the wheeled container 100, as described herein. The method 200 may include a step 204 of positioning the handle 102 of the wheeled container 100 in the secured handle position during storage of the wheeled container 100. A step 206 may include positioning the handle 102 of the wheeled container 100 in the extended position during transport of the wheeled container 100.

Additional steps relating to assembling the wheeled container 100, placing storage items in the interior cavity 122 of the wheeled container 100, coupling the lid 127 to the wheeled container 100, tilting the wheeled container 100, utilizing the hand grip 130, and pushing and/or pulling the wheeled container 100 using the handle 102 in the extended position, as examples, may be included in the method 200. Steps relating to stacking the plurality of wheeled containers 100 may also be included in the method 200. It should be appreciated that steps may be omitted, added, and/or repeated, as determined by one of skill in the art.

Advantageously, the wheeled container 100 may facilitate efficient manufacturing using integrated components and a simplified assembly process. The handle 102 including the integrally formed pins 154 having slots 156 configured to be compressed may allow for direct insertion into the cylindrical apertures 148 of each of the first and second mounting components 142, 151 without requiring additional assembly steps, specialized tools, or additional components. The pins 154 may be configured to be resiliently compressed or pinched together to facilitate insertion into the cylindrical apertures 148. The ledge 158 disposed on the distal end 167 of each pin 154 may engage with the exterior surface 170 of each of the first and second mounting components 142, 151 upon insertion to secure the handle 102 in place with respect to the wheeled container 100.

Each of the first and second mounting components 142, 151 may be co-formed with the flange 126 during the molding process, thereby enhancing the structural integrity of each of the first and second mounting components 142, 151 and the flange 126. The stay ribs 162 and corresponding protrusions 160 may provide secure handle retention using geometric interaction rather than requiring separate fastening hardware. The wheeled container 100 may be manufactured from plastic through injection molding or blow molding processes, allowing structural features such as the wheel wells 132, 134, the first and second mounting components 142, 151, and the support ribs 128, as examples, to be integrally formed with one another, thereby reducing the number of separate components and assembly steps required while maintaining full functionality through the interaction of molded features.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A container comprising:
a base wall having a peripheral edge;
a first side wall and a second side wall disposed opposite the first side wall, each of the first side wall and the second side wall extending upwardly from the peripheral edge of the base wall;
a first end wall and a second end wall disposed opposite the first end wall, each of the first end wall and the second end wall extending upwardly from the peripheral edge of the base wall;
a first mounting component and a second mounting component disposed on the second end wall, each of the first mounting component and the second mounting component including an L-shaped component and an aperture formed in the L-shaped component; and
a handle including a first pin configured to couple to the first mounting component and a second pin configured to couple to the second mounting component;
wherein the handle is configured to rotate between a secured handle position and an extended position.

2. The container of claim 1, wherein an upper edge of each one of the first side wall, the
second side wall, the first end wall, and the second end wall defines an opening configured to provide access to a hollow interior cavity container, and wherein a lip extends outwardly from a perimeter of the opening

3. The container of claim 2, wherein the container includes a flange extending outwardly from and circumscribing the lip, and wherein the flange includes a first flange section and a second flange section, the first flange section having a first flange height that is greater than a second flange height of the second flange section.

4. The container of claim 3, wherein the container includes a first hand grip disposed centrally adjacent the first end wall and a second hand grip disposed generally central adjacent the second end wall, wherein each of the first hand grip and the second hand grip includes a first end and a second end disposed opposite the first end, and wherein each of the first hand grip and the second hand grip are positioned adjacent a second flange section at the first end and a second flange section at the second end.

5. The container of claim 3, wherein the container includes a plurality of support ribs disposed adjacent the flange, the plurality of support ribs including a first support rib having a first support rib height and a second support rib having a second support rib height, and wherein the first support rib height is the same as the first flange height and the second support rib height is the same as the second flange height.

6. The container of claim 1, wherein a hand grip disposed centrally adjacent the second end wall includes a first end and a second end disposed opposite the first end, and wherein the first mounting component is positioned adjacent the first end of the hand grip and the second mounting component is positioned adjacent the second end of the hand grip.

7. The container of claim 3, wherein the first mounting component includes a first back section co-formed with a first co-forming flange having the first flange height and the second mounting component includes a second back section co-formed with a second co-forming flange having the first flange height.

8. The container of claim 7, wherein the second flange section having the second flange height is disposed between the first co-forming flange and the second co-forming flange.

9. The container of claim 1, wherein the first mounting component includes a first back section, the first back section having a first end and a second end disposed opposite the first end, a first L-shaped component positioned adjacent the first end of the first back section, a second L-shaped component positioned adjacent the second end of the first back section, and a first connecting wall extending from the first L-shaped component to the second L-shaped component, and wherein the second mounting component includes a second back section, the second back section having a third end and a fourth end disposed opposite the third end, a third L-shaped component positioned adjacent the third end of the second back section, a fourth L-shaped component positioned adjacent the fourth end of the second back section, and a second connecting wall extending from the third L-shaped component to the fourth L-shaped component.

10. The container of claim 9, wherein the first L-shaped component includes a first aperture, the second L-shaped component includes a second aperture, the third L-shaped component includes a third aperture, and the fourth L-shaped component includes a fourth aperture, and wherein each of the first aperture, the second aperture, the third aperture, and the fourth aperture is in alignment.

11. The container of claim 10, wherein the first pin rotatably couples to each of the first L-shaped component and the second L-shaped component and the second pin rotatably couples to each of the third L-shaped component and the fourth L-shaped component.

12. The container of claim 11, wherein the first pin includes a first recessed area formed in a first distal end and a first ledge extending radially outward from the first distal end and the second pin includes a second recessed area formed in a second distal end and a second ledge extending radially outward from the second distal end.

13. The container of claim 12, wherein the first recessed area is configured to allow the first pin to be compressed during insertion through the first aperture and the second aperture, and the second recessed area is configured to allow the second pin to be compressed during insertion through the third aperture and the fourth aperture.

14. The container of claim 12, wherein the first ledge is positioned adjacent a first exterior surface of the second L-shaped component, and the second ledge is positioned adjacent a second exterior surface of the third L-shaped component.

15. The container of claim 11, wherein a first set of protrusions disposed on the first L-shaped component is configured to receive a first stay rib disposed adjacent the first pin, and a second set of protrusions disposed on the fourth L-shaped component is configured to receive a second stay rib disposed adjacent the second pin.

16. The container of claim 1, wherein a first wheel well is formed in the base wall, the first side wall, and the first end wall, and a second wheel well is formed in the base wall, the second side wall, and the first end wall.

17. The container of claim 16, wherein an axle extends between the first wheel and the second wheel.

18. The container of claim 1, wherein the handle includes a side wall, a front wall, and a rear wall, and wherein a plurality of handle support ribs is formed between the side wall, the front wall, and the rear wall.

19. A container comprising:
a base wall having a peripheral edge;
a first side wall and a second side wall disposed opposite the first side wall, each of the first side wall and the second side wall extending upwardly from the peripheral edge of the base wall;
a first end wall and a second end wall disposed opposite the first end wall, each of the first end wall and the second end wall extending upwardly from the peripheral edge of the base wall;
a lip extending outwardly from a perimeter of an opening formed by an upper edge of the first side wall, the second side wall, the first end wall, and the second end wall;
a flange extending outwardly from and circumscribing the lip, and wherein the flange includes a first flange section and a second flange section, the first flange section having a first flange height that is greater than a second flange height of the second flange section;
first wheel well formed in the base wall, the first side wall, and the first end wall, and a second wheel well formed in the base wall, the second side wall, and the first end wall;
a first wheel disposed in the first wheel well and a second wheel disposed in the second wheel well;
a first mounting component and a second mounting component disposed on the second end wall, each of the first mounting component and the second mounting component including an L-shaped component and an aperture formed in the L-shaped component;
a hand grip disposed centrally adjacent the second end wall including a first end and a second end disposed opposite the first end; and
a handle including a first pin configured to couple to the first mounting component and a second pin configured to couple to the second mounting component;
wherein the handle is configured to rotate between a secured handle position and an extended position; and
wherein the first mounting component is positioned adjacent the first end of the hand grip and the second mounting component is positioned adjacent the second end of the hand grip.

20. A method of using a container, including:
providing a container having:
a base wall having a peripheral edge;
a first side wall and a second side wall disposed opposite the first side wall, each of the first side wall and the second side wall extending upwardly from the peripheral edge of the base wall;
a first end wall and a second end wall disposed opposite the first end wall, each of the first end wall and the second end wall extending upwardly from the peripheral edge of the base wall;
a first mounting component and a second mounting component disposed on the second end wall, each of the first mounting component and the second mounting component including an L-shaped component and an aperture formed in the L-shaped component; and
a handle including a first pin configured to couple to the first mounting component and a second pin configured to couple to the second mounting component;
wherein the handle is configured to rotate between a secured handle position and an extended position,
placing the handle in the secured handle position during storage of the container; and
placing the handle in the extended position during transport of the container.
